(19) United States
(12) Patent Application Publication
(10) Pub. No.: US 2026/0249615 A1
(43) Pub. Date: Aug. 27, 2026

(54) LIQUID EJECTING APPARATUS AND METHOD FOR REUSING LIQUID ACCOMMODATING BODY

(71) Applicant: SEIKO EPSON CORPORATION, Tokyo (JP)

(72) Inventor: Masaki UCHIYAMA, Azumino-shi (JP)

(73) Assignee: SEIKO EPSON CORPORATION, Tokyo (JP)

(21) Appl. No.: 19/547,858

(22) Filed: Feb. 24, 2026

(30) Foreign Application Priority Data
Feb. 25, 2025 (JP) 2025-027645

(51) Int. Cl. B41J 2/17; B41J 2/175

(52) U.S. Cl. CPC B41J 2/1735; B41J 2/17509; B41J 2/17513; B41J 2/17523; B41J 2/17553; B41J 2/17596; B41J 2002/17516

(57) ABSTRACT

A liquid ejecting apparatus includes: a print head; a liquid accommodating body holder in which a liquid accommodating body is housed; and a waste liquid accommodating body holder in which a waste liquid accommodating body is housed, and the waste liquid accommodating body holder is formed in the same shape as the liquid accommodating body holder, and is mountable on a used liquid accommodating body.

### CROSS-REFERENCE TO RELATED APPLICATIONS

The present application is based on, and claims priority from JP Application Serial Number 2025-027645, filed February 25, 2025, the disclosure of which is hereby incorporated by reference herein in its entirety.

### BACKGROUND

### Technical Field

The present disclosure relates to a liquid ejecting apparatus and a method for reusing a liquid accommodating body.

### Related Art

In the related art, a liquid ejecting apparatus including a liquid accommodating body and a waste liquid accommodating body is known. The apparatus uses the liquid supplied from the liquid accommodating body for printing or the like, and collects the waste liquid generated in the maintenance operation or the like in the waste liquid accommodating body. For example, JP-A-2024-159624 discloses a recording system including a container and a waste liquid cartridge.

However, the recording system described in JP-A-2024-159624 has a problem that a method for reusing the used container is not disclosed. That is, there is a demand for a liquid ejecting apparatus that reuses a used liquid accommodating body to reduce environmental impact.

### SUMMARY

A liquid ejecting apparatus includes: a print head; a liquid accommodating body holder in which a liquid accommodating body is housed; and a waste liquid accommodating body holder in which a waste liquid accommodating body is housed, and the waste liquid accommodating body holder is formed in the same shape as the liquid accommodating body holder, and is mountable on a used liquid accommodating body.

A method for reusing a liquid accommodating body, includes: in the liquid ejecting apparatus, removing the used liquid accommodating body from the liquid accommodating body holder; and attaching the removed used liquid accommodating body to the waste liquid accommodating body holder.

### BRIEF DESCRIPTION OF THE DRAWINGS

FIG. 1 is a schematic view of a liquid ejecting apparatus according to an embodiment.

FIG. 2 is a perspective view illustrating an appearance of a liquid accommodating body holder in which a liquid accommodating body is housed and a waste liquid accommodating body holder in which a waste liquid accommodating body is housed.

FIG. 3 is a schematic view illustrating an appearance of a liquid accommodating body filled with ink.

FIG. 4 is a schematic view illustrating an appearance of a used liquid accommodating body.

FIG. 5 is a schematic view illustrating a configuration of a waste liquid collecting section and a method for reusing a liquid accommodating body.

FIG. 6 is a schematic view illustrating a method for reusing a liquid accommodating body.

FIG. 7 is a schematic view illustrating the method for reusing a liquid accommodating body.

### DESCRIPTION OF EMBODIMENTS

In the embodiments described below, a large format ink jet printer is exemplified as a liquid ejecting apparatus 10, and the embodiments will be described with reference to the drawings. The liquid ejecting apparatus of the present disclosure is not limited to a large format type ink jet printer.

In each of the following drawings, an XYZ axis is attached as a coordinate axis orthogonal to each other as necessary, a direction indicated by each arrow is a + direction, and a direction opposite to the + direction is a

direction. When the liquid ejecting apparatus 10 is installed on the horizontal plane, the Z axis extends in the vertical direction. The -Y direction may be the rearward, the +Z direction may be the upward, and the -Z direction may be the downward. For convenience of illustration, the size of each member is different from the actual size.

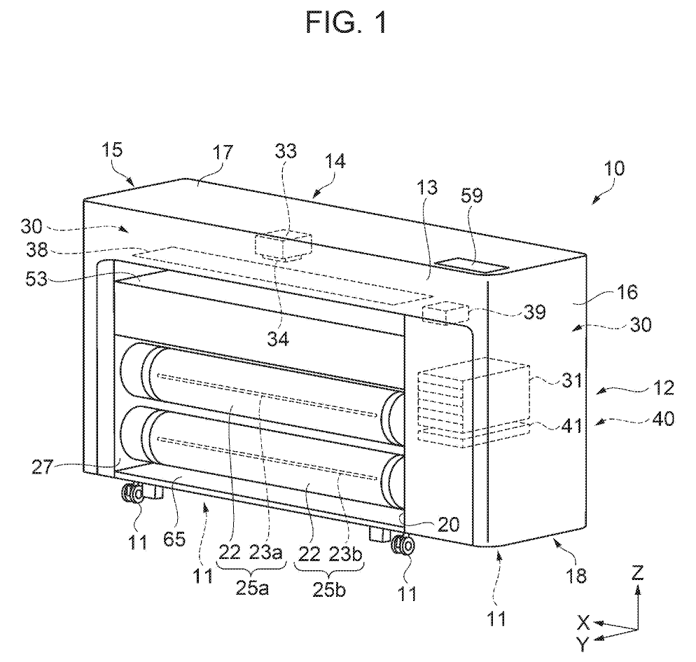

As illustrated in FIG. 1, the liquid ejecting apparatus 10 according to the present embodiment includes a medium holding section 20, a recording section 30, a waste liquid collecting section 40, and a housing 12 which is an exterior member. The liquid ejecting apparatus 10 also includes a control section (not illustrated). The liquid ejecting apparatus 10 performs printing on a medium 22 wound around the roll bodies 25a and 25b.

The housing 12 includes a front surface 13, a back surface 14, side surfaces 15 and 16, an upper surface 17, and a bottom surface 18. The housing 12 has a substantially rectangular parallelepiped shape that is long in the direction along the X axis and high in the up-down direction. An input section 59 is disposed on the upper surface 17 of the housing 12 in the -X direction and the +Y direction. A paper discharge port 53 and a roll body accommodation port 27 are disposed on the front surface 13. The bottom surface 18 is provided with four leg sections 11.

The four leg sections 11 are wheel casters. The four leg sections 11 are disposed on the bottom surface 18. The four leg sections 11 support the liquid ejecting apparatus 10 from below and facilitate the movement of the liquid ejecting apparatus 10 by the wheels.

Inside the housing 12, a medium holding section 20, a recording section 30, and a waste liquid collecting section 40 are disposed. Although not illustrated, a transport path of the medium 22, a frame which is a skeleton of the liquid ejecting apparatus 10, and a control section are also disposed inside the housing 12. In the following description, the transport path of the medium 22 in the liquid ejecting apparatus 10 is also simply referred to as a transport path.

The transport path extends from the roll bodies 25a and 25b supported in the vicinity below the front surface 13 substantially rearward and substantially upward along the back surface 14. The transport path is bent in the +Y direction in the vicinity of the upper part of the back surface 14, and continues to the paper discharge port 53 through a support section 38 of the recording section 30. The medium 22 is transported along a transport path by a plurality of transport rollers (not illustrated), printed, and discharged from the paper discharge port 53.

The control section includes a central processing unit (CPU), a system bus, a read only memory (ROM), a random access memory (RAM), and the like. The control section is electrically coupled to each component of the liquid ejecting apparatus 10 and integrally controls the operation of the liquid ejecting apparatus 10. The liquid ejecting apparatus 10 may be operated from an information device such as a personal computer via a control section.

The input section 59 is, for example, a touch panel type liquid crystal display device. The input section 59 is electrically coupled to the control section. Various instructions are input to the input section 59 from the operator of the liquid ejecting apparatus 10, and various information related to the liquid ejecting apparatus 10 is displayed. The input section 59 may have a physical button.

The roll body accommodation port 27 is a substantially rectangular opening portion corresponding to the two roll bodies 25a and 25b. The roll body accommodation port 27 extends from the vicinity of the bottom surface 18 of the housing 12 to the middle of the height of the housing 12 in the up-down direction, and is longer than the lengths of the roll bodies 25a and 25b in the direction along the X axis. The roll bodies 25a and 25b are visually recognized through the roll body accommodation port 27 from the +Y direction.

The medium 22 before printing is wound around a core member 23a to form a roll body 25a, and is wound around the core member 23b to form the roll body 25b. The roll bodies 25a and 25b have a substantially cylindrical shape, and the height direction of the cylinder is along the X axis. The roll body 25b is disposed in the vicinity of the bottom surface 18 of the housing 12, and the roll body 25a is disposed above the roll body 25b. Examples of the medium 22 include paper such as coated paper, a resin sheet such as vinyl, and cloth. A dimension of the medium 22 applicable to the liquid ejecting apparatus 10 along the X axis, that is, a width is not particularly limited, but is, for example, 16 inches or more and 44 inches or less.

The medium holding section 20 holds the roll bodies 25a and 25b and supplies the medium 22 before printing from the roll bodies 25a and 25b to the transport path. The medium 22 is transported from the medium holding section 20 to the recording section 30.

The recording section 30 performs printing on the medium 22. The recording section 30 includes a liquid accommodating body holder 31, a carriage 33, a print head 34, a support section 38, and a suction section 39. The recording section 30 performs printing by discharging a liquid such as ink from the print head 34 to the medium 22.

The liquid accommodating body holder 31 supplies a liquid such as ink to the print head 34. The liquid accommodating body holder 31 is disposed in the housing 12 in the -X direction of the roll body accommodation port 27. Although not illustrated, a plurality of liquid accommodating bodies can be attached to and detached from the liquid accommodating body holder 31. The liquid such as ink is individually supplied to the print head 34 from the plurality of liquid accommodating bodies via a liquid pipe (not illustrated), a liquid feed pump (not illustrated), or the like. The attachment/detachment work of the liquid accommodating body is performed by opening a door (not illustrated) provided on the front surface 13. The disposition of the liquid accommodating body holder 31 is not limited to the above, and for example, the liquid accommodating body holder 31 may be disposed in the +X direction of the roll body accommodation port 27, and may be divided and disposed in the -X direction and the +X direction of the roll body accommodation port 27.

For example, the plurality of liquid accommodating bodies accommodate inks having each color such as black, cyan, magenta, yellow, light cyan, and light magenta. In addition, the liquid accommodating body may accommodate a liquid such as clear ink or a treatment solution.

The carriage 33 holds the print head 34. The carriage 33 is disposed above the housing 12 and in the vicinity of the upper surface 17. The carriage 33 is supported by the frame and reciprocates along the X axis by driving a carriage motor (not illustrated). The region where the carriage 33 moves includes a region facing the support section 38 and the suction section 39 in the up-down direction.

The print head 34 is disposed below the carriage 33. The print head 34 has a nozzle surface (not illustrated) at a position facing the support section 38. A plurality of nozzle rows are disposed on the nozzle surface. Each of the plurality of nozzle rows includes a plurality of nozzles, and individually discharges the liquid such as the ink described above.

A piezoelectric element is applied to the print head 34 as an actuator which is a drive unit. The drive unit of the print head 34 is not limited to the piezoelectric element. For example, as the drive unit, an electromechanical conversion element that displaces a diaphragm as an actuator by electrostatic adsorption, or an electrothermal conversion element that discharges ink or the like as a droplet by air bubbles generated by heating may be applied.

The support section 38 is a so-called platen, and supports the medium 22 from below when the print head 34 performs printing on the medium 22. The support section 38 has a substantially rectangular shape elongated in the X direction, and is provided to correspond to a range in which the carriage 33 reciprocates.

The medium 22 is transported in the +Y direction when the print head 34 is reciprocated in the direction along the X axis together with the carriage 33. At this time, a desired image or the like is printed on the medium 22 by adhering a liquid such as ink to the medium 22 from the print head 34 at a predetermined timing.

The suction section 39 sucks a liquid such as ink from the print head 34 to perform a maintenance operation of the print head 34. The suction section 39 is disposed in the -X direction of the support section 38. In the maintenance operation, the print head 34 moves upward of the suction section 39, and the suction section 39 is driven by an electric motor (not illustrated) to rise. Then, the suction pump of the waste liquid collecting section 40, which will be described later, is operated in a state where the suction section 39 is in close contact with the nozzle surface of the print head 34, and the liquid such as ink is sucked from the plurality of nozzles. The disposition of the suction section 39 is not limited to the above, and for example, the suction section 39 may be disposed in the +X direction of the support section 38, or may be disposed on both sides of the support section 38 in the -X direction and the +X direction.

As a result, the liquid such as the dried ink is removed from the plurality of nozzles, and the cleaning of the print head 34 is performed. In addition, the suction section 39 also performs flushing discharge of the print head 34. The liquid such as the ink sucked by the suction section 39 is collected as a waste liquid in the waste liquid collecting section 40. Details of the collection of the waste liquid will be described later.

The waste liquid collecting section 40 includes a waste liquid accommodating body holder 41. The waste liquid collecting section 40 collects the waste liquid generated in the maintenance operation of the print head 34 or the like. The waste liquid accommodating body holder 41 is located inside the housing 12 and is disposed below the liquid accommodating body holder 31. A waste liquid accommodating body to be described later can be attached to and detached from the waste liquid accommodating body holder 41. In the waste liquid collecting section 40, the waste liquid is collected in the waste liquid accommodating body from the suction section 39 via the suction pump described above, the liquid flow path to be described later, or the like. The attachment/detachment work of the waste liquid accommodating body is performed by opening a door (not illustrated) provided on the front surface 13, in the same manner as the attachment/detachment work of the liquid accommodating body. The disposition of the waste liquid accommodating body holder 41 is not limited to the above, and may be disposed in the +X direction of the roll body accommodation port 27, for example, as in the liquid accommodating body holder 31, or may be disposed on both sides of the roll body accommodation port 27 in the -X direction and the +X direction.

Here, the liquid ejecting apparatus in the related art includes a waste liquid tank, a waste liquid absorber, and the like. These members have different shapes from the liquid accommodating body, and the used liquid accommodating body has no other use. On the other hand, in the liquid ejecting apparatus 10 of the present embodiment, since the liquid accommodating body and the waste liquid accommodating body are compatible with each other, the used liquid accommodating body can be reused as the waste liquid accommodating body.

Although not illustrated, the cutting section is disposed in the +Y direction of the support section 38. The cutting section cuts the medium 22, on which printing is performed, along the X axis. The medium 22 is cut from the band shape to the single sheet shape by the cutting section. The medium 22, on which printing is performed, does not necessarily have to be cut by the cutting section.

In the paper discharge port 53, the medium 22, on which printing is performed, is discharged in the substantially +Y direction. The paper discharge port 53 is disposed above the roll body accommodation port 27. The paper discharge port 53 is an elongated slit in the direction along the X axis corresponding to the width, which is a dimension of the medium 22 along the X axis.

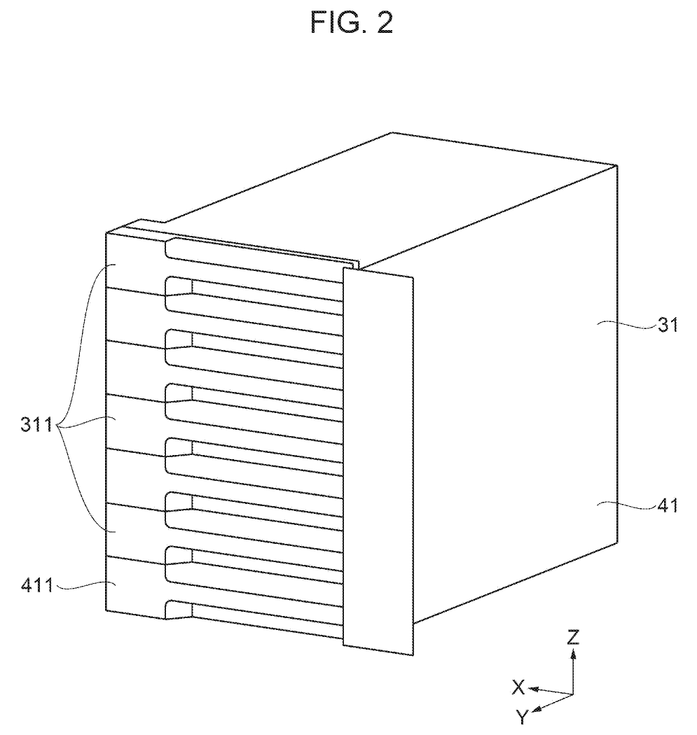

As illustrated in FIG. 2, six liquid accommodating bodies 311 are housed in the liquid accommodating body holder 31. One waste liquid accommodating body 411 is housed in the waste liquid accommodating body holder 41. The liquid accommodating body holder 31 and the waste liquid accommodating body holder 41 have a substantially rectangular parallelepiped shape. In the liquid accommodating body holder 31, the six liquid accommodating bodies 311 are disposed to be overlapped in the up-down direction. The waste liquid accommodating body holder 41 is located immediately below the liquid accommodating body holder 31 and is formed integrally with the liquid accommodating body holder 31. In the waste liquid accommodating body holder 41, the waste liquid accommodating body 411 is disposed to be overlapped below the lowermost liquid accommodating body 311.

In the present embodiment, the liquid accommodating body holder 31 and the waste liquid accommodating body holder 41 are integrally formed with a sheet metal member or the like. The liquid accommodating body holder 31 and the waste liquid accommodating body holder 41 are not limited to being integrated. The waste liquid accommodating body holder 41 is not limited to being disposed immediately below the liquid accommodating body holder 31. The number of liquid accommodating bodies 311 housed in the liquid accommodating body holder 31 and the number of waste liquid accommodating bodies 411 accommodated in the waste liquid accommodating body holder 41 are not limited to the above-described numbers.

The waste liquid accommodating body holder 41 is formed in the same shape as the liquid accommodating body holder 31. Therefore, the used liquid accommodating body 311 in which the liquid such as ink is used up can be mounted on the waste liquid accommodating body holder 41. The same shape as referred to here means that the liquid accommodating body 311 and the waste liquid accommodating body 411 are compatible with each other when attached to and detached from or used. The liquid accommodating body holder 31 and the waste liquid accommodating body holder 41 may not necessarily have the same shape as each other in terms of the shape and configuration unrelated to the compatibility.

The liquid accommodating body 311 is inserted into the liquid accommodating body holder 31 in the -Y direction and mounted. The liquid accommodating body 311 is pulled out and removed in the +Y direction from this state. Similarly, the waste liquid accommodating body 411 or the used liquid accommodating body 311 is inserted into the waste liquid accommodating body holder 41 in the -Y direction and mounted. In this state, the waste liquid accommodating body 411 or the used liquid accommodating body 311 is pulled out and removed in the +Y direction.

In the liquid accommodating body holder 31, the position for mounting the various liquid accommodating bodies 311 is determined according to the type such as the color type. Therefore, the liquid accommodating body holder 31 may be provided with a mechanism for preventing erroneous mounting of the liquid accommodating body 311.

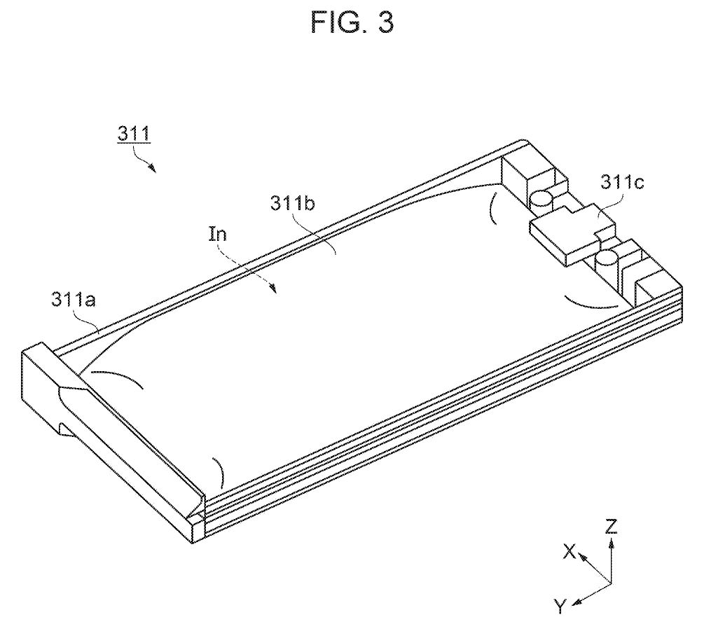

As illustrated in FIG. 3, the liquid accommodating body 311 includes a frame member 311a, a bag-like member 311b, and a supply member 311c. The liquid accommodating body 311 has a substantially rectangular parallelepiped shape, and has a short dimension in the up-down direction.

The frame member 311a is a substantially box-shaped exterior member that is open upward, and accommodates the bag-like member 311b therein. The supply member 311c is disposed at the end portion of the frame member 311a in the -Y direction. The frame member 311a is assembled with a plurality of components such as a resin and a metal.

The bag-like member 311b is substantially rectangular when viewed from above, and is filled with a liquid In such as ink inside. In the bag-like member 311b, for example, a plurality of films that suppress permeation of moisture and gas are laminated. The bag-like member 311b has resistance not to be eroded by the liquid In. FIG. 3 illustrates the bag-like member 311b charged with the liquid In. Since the bag-like member 311b is filled with the liquid In, the bag-like member 311b is slightly swollen in the up-down direction. Although not particularly limited, the content volume of the bag-like member 311b is, for example, about 1.5 L.

The supply member 311c is coupled to the end portion of the bag-like member 311b in the -Y direction, and is exposed to the outside on the surface of the frame member 311a facing the -Y direction. A flow path (not illustrated) of the liquid In is provided inside the supply member 311c. The flow path allows the inside of the bag-like member 311b and the outside of the liquid accommodating body 311 to communicate with each other. The flow path is provided with a valve that prevents the liquid In filled in the bag-like member 311b from leaking.

When the liquid accommodating body 311 is mounted on the liquid accommodating body holder 31, the liquid In can be supplied from the supply member 311c to the print head 34. When the used liquid accommodating body 311 is used as the waste liquid accommodating body 411, the supply member 311c also functions as an introduction port for introducing the waste liquid into the bag-like member 311b.

Here, the liquid accommodating body 311 may be provided with a lid member that covers the upper part of the frame member 311a. The waste liquid accommodating body 411 has the same configuration and substantially the same shape as the liquid accommodating body 311. In the following description, a case where the used liquid accommodating body 311 is used as the waste liquid accommodating body 411 will be described, but a new waste liquid accommodating body 411 may be used. The liquid accommodating body 311 that is used and has a liquid such as ink remaining therein can also be used as the waste liquid accommodating body 411. In addition, it is preferable that the liquid accommodating body 311 is not used for two or more times for the purpose of accommodating the waste liquid.

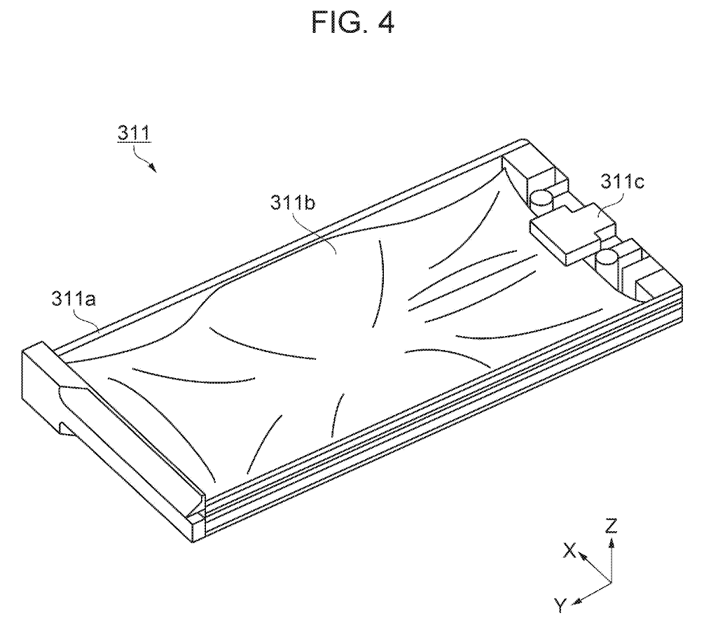

As illustrated in FIG. 4, in the used liquid accommodating body 311, the liquid In is sucked from the bag-like member 311b, and the bag-like member 311b is substantially empty. The bag-like member 311b has almost no gas such as air inside, and wrinkles are generated in various places. When the used liquid accommodating body 311 is used as the waste liquid accommodating body 411, the waste liquid is filled in the bag-like member 311b from the state illustrated in the drawing.

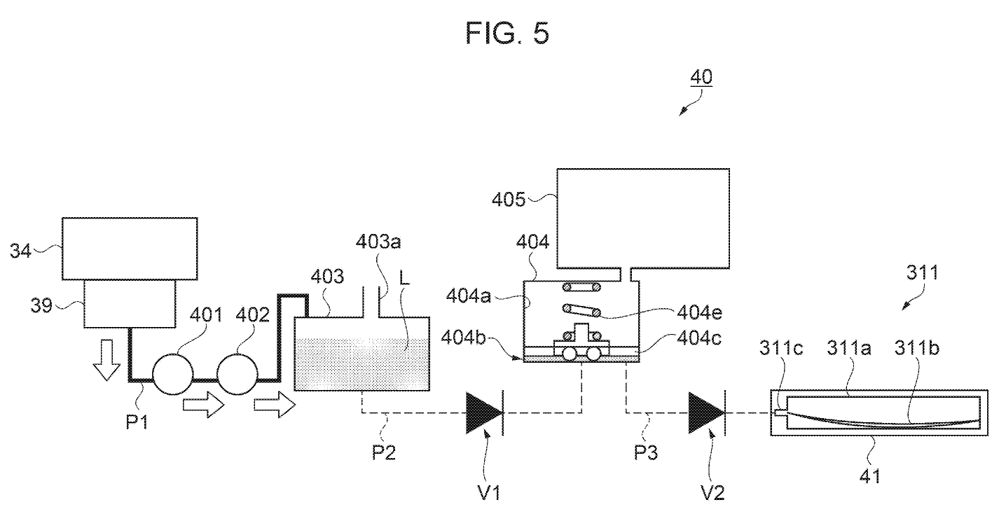

Hereinafter, a detailed configuration of the waste liquid collecting section 40 and a method for reusing the used liquid accommodating body 311 will be described with reference to FIGS. 5 to 7.

As illustrated in FIG. 5, the waste liquid collecting section 40 includes liquid flow paths P1, P2, and P3, a suction pump 401, a switching valve 402, a waste liquid storage tank 403, check valves V1 and V2, a buffer 404, a decompression pump 405, and a waste liquid accommodating body holder 41. FIG. 5 illustrates a state where the used liquid accommodating body 311 is mounted on the waste liquid accommodating body holder 41.

The liquid flow paths P1, P2, and P3 are flow paths of a waste liquid L, and couple the suction section 39 and the waste liquid accommodating body holder 41 to each other. The liquid flow path P1, the liquid flow path P2, and the liquid flow path P3 are disposed in this order from the suction section 39 toward the waste liquid accommodating body holder 41. Here, in the path of the waste liquid L including the liquid flow paths P1, P2, and P3, the side of the suction section 39 is referred to as the upstream, and the side of the waste liquid accommodating body holder 41 is referred to as the downstream.

The liquid flow path P1 is provided with the suction pump 401 and the switching valve 402. The waste liquid storage tank 403 is provided between the liquid flow path P1 and the liquid flow path P2. The check valve V1 is provided in the liquid flow path P2. The buffer 404 is provided between the liquid flow path P2 and the liquid flow path P3. The check valve V2 is provided in the liquid flow path P3.

The liquid flow path P1 allows the inside of the suction section 39 and the inside of the waste liquid storage tank 403 to communicate with each other. The suction pump 401 is disposed upstream of the switching valve 402.

The suction pump 401 generates a negative pressure in the suction section 39 that is in close contact with the print head 34 in the maintenance operation of the print head 34. As a result, the suction section 39 sucks the liquid In such as ink from the print head 34. The liquid In such as the ink sucked by the suction section 39 becomes the waste liquid L and flows into the liquid flow path P1.

The switching valve 402 prevents the waste liquid L from flowing back from the waste liquid storage tank 403 disposed downstream to the upstream. The switching valve 402 is a solenoid valve, and switches between opening and closing of the liquid flow path P1.

The waste liquid storage tank 403 temporarily accommodates the waste liquid L sucked from the print head 34. The waste liquid storage tank 403 has an atmosphere opening valve 403a that allows the inside and the outside where the waste liquid L is stored to communicate with each other.

The check valve V1 allows the waste liquid L to flow from the upstream to the downstream in the liquid flow path P2, and restricts the backflow of the waste liquid L or the gas from the downstream to the upstream. Specifically, the check valve V1 prevents the waste liquid L from flowing back from the buffer 404 to the waste liquid storage tank 403.

The buffer 404 sucks the waste liquid L stored in the waste liquid storage tank 403 via the liquid flow path P2, and sends out the sucked waste liquid L to the liquid flow path P3. The buffer 404 is a so-called diaphragm pump. The buffer 404 includes inner chambers 404a and 404b, a rubber film-like valve 404c, and a spring 404e. The decompression pump 405 is coupled to the buffer 404.

The inner chambers 404a and 404b are internal spaces of the buffer 404. The inner chamber 404a and the inner chamber 404b are isolated from each other by the film-like valve 404c. The inner chamber 404a is decompressed when the decompression pump 405 operates. When the decompression pump 405 is stopped, air flows into the inner chamber 404a. The inner chamber 404b communicates with the liquid flow paths P2 and P3.

The film-like valve 404c is attached to the inner wall of the buffer 404 at the boundary between the inner chamber 404a and the inner chamber 404b. The spring 404e is disposed on the inner chamber 404a side of the film-like valve 404c. One end of the spring 404e is fixed to the inner wall of the inner chamber 404b, and the other end is fixed to the film-like valve 404c. The spring 404e biases the film-like valve 404c to reduce the volume of the inner chamber 404b. FIG. 5 illustrates a state where the volume of the inner chamber 404b is reduced.

The decompression pump 405 decompresses the inner chamber 404a. When the inside of the inner chamber 404a is decompressed, the center of the film-like valve 404c is deformed to be pulled toward the inner chamber 404a side against the biasing of the spring 404e. As a result, the volume of the inner chamber 404b is expanded, and the waste liquid L in the waste liquid storage tank 403 is drawn into the inner chamber 404b via the liquid flow path P2.

When the decompression pump 405 is stopped, the inner chamber 404a is opened to the atmosphere, and the deformation of the film-like valve 404c is restored by the biasing of the spring 404e. As a result, the waste liquid L flowing into the inner chamber 404b is sent out to the liquid flow path P3. At this time, the waste liquid L does not flow back from the buffer 404 to the waste liquid storage tank 403 by the check valve V1.

The check valve V2 allows the waste liquid L to flow from the upstream to the downstream in the liquid flow path P3, and restricts the backflow of the waste liquid L from the downstream to the upstream. Specifically, the check valve V2 prevents the waste liquid L from flowing back from the used liquid accommodating body 311 to the buffer 404.

When the used liquid accommodating body 311 is mounted on the waste liquid accommodating body holder 41 on the downstream of the liquid flow path P3, the downstream of the liquid flow path P3 communicates with the inside of the bag-like member 311b via the supply member 311c. With the above configuration, the waste liquid L can be reliably accommodated in the used liquid accommodating body 311. The configurations of the liquid ejecting apparatus 10 and the waste liquid collecting section 40 described above are examples. The liquid ejecting apparatus of the present disclosure is not limited to the above-described configuration.

The method for reusing the used liquid accommodating body 311 according to the present embodiment, includes: in the liquid ejecting apparatus 10, removing the used liquid accommodating body 311 from the liquid accommodating body holder 31; and attaching the removed used liquid accommodating body 311 to the waste liquid accommodating body holder 41. The used liquid accommodating body 311 removed in the removing step may be temporarily stored between the removing step and the attaching step. In addition, a step of removing the used liquid accommodating body 311 filled with the waste liquid L from the waste liquid accommodating body holder 41 may be added before the above-mentioned attaching step.

In order to reuse the used liquid accommodating body 311, the waste liquid L is collected in the used liquid accommodating body 311 in the waste liquid collecting section 40 after the step of attaching the used liquid accommodating body 311 to the waste liquid accommodating body holder 41. That is, the waste liquid L generated by the maintenance operation of the print head 34 or the like is collected each time, and this process is repeated until the used liquid accommodating body 311 becomes full with the waste liquid L.

As illustrated in FIG. 5, the suction pump 401 is operated by bringing the suction section 39 into close contact with the print head 34. At this time, the switching valve 402 is opened, and the waste liquid L sucked by the suction pump 401 is sent to the waste liquid storage tank 403 and stored. Here, in FIGS. 5 to 7, among the liquid flow paths P1, P2, and P3, the one through which the waste liquid L is flowing is represented by a solid line, and the one through which the waste liquid L is not flowing is represented by a broken line. In addition, in the liquid flow paths P1, P2, and P3, the direction in which the waste liquid L flows is indicated by a white arrow.

When the waste liquid L is accommodated in the waste liquid storage tank 403, the switching valve 402 and the atmosphere opening valve 403a of the waste liquid storage tank 403 are set to the open state. As a result, the air in the waste liquid storage tank 403 is released to the outside as much as the waste liquid L flowing in, and the waste liquid L does not flow into the liquid flow path P2. Therefore, air is removed from the waste liquid L sent downstream from the waste liquid storage tank 403, and the mixing of air into the waste liquid L filled in the used liquid accommodating body 311 can be prevented.

In the maintenance operation of the print head 34, air such as air bubbles is likely to be mixed in the waste liquid L by the suction of the suction pump 401. Therefore, the waste liquid L is temporarily stored in the waste liquid storage tank 403, and the air such as air bubbles mixed in the waste liquid L is separated from the waste liquid L. As a result, the mixing of air into the used liquid accommodating body 311 is suppressed, and the filling rate of the waste liquid L is improved.

It is preferable that the atmosphere opening valve 403a is closed except for the maintenance operation of the print head 34. As a result, drying and thickening of the waste liquid stored in the waste liquid storage tank 403 can be suppressed.

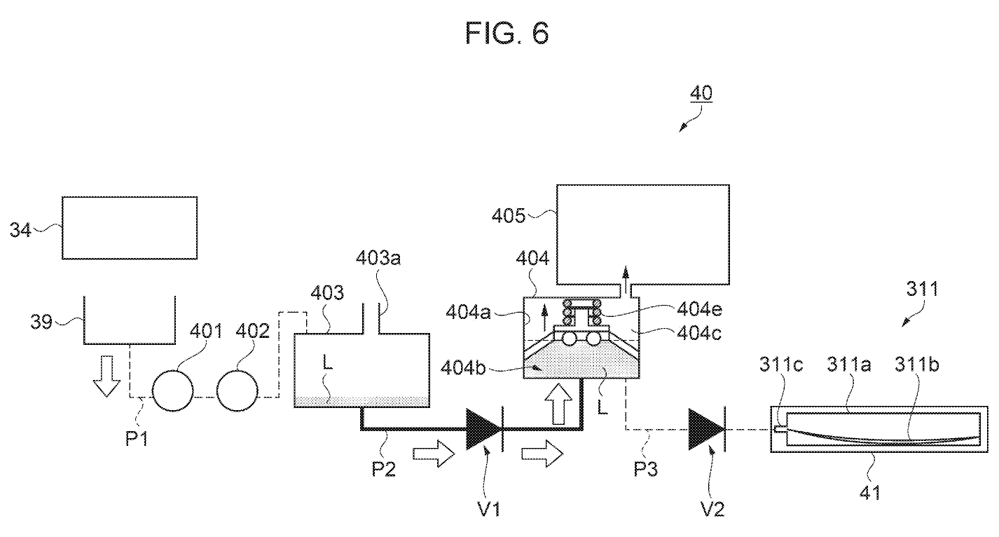

As illustrated in FIG. 6, when the maintenance operation of the print head 34 is ended, the suction pump 401 is stopped and the suction section 39 is separated from the print head 34. The print head 34 and the suction section 39 do not necessarily have to be separated from each other when the maintenance operation is ended. When the switching valve 402 is in the closed state, the liquid such as ink is not sucked from the print head 34, and thus the suction section 39 may be brought into close contact with the print head 34. As a result, drying in the nozzle of the print head 34 is suppressed. FIG. 6 illustrates a state where both are separated from each other in order to discharge the waste liquid L remaining in the suction section 39. Further, even in such a situation, when the suction section 39 is provided with a so-called atmosphere opening valve that opens the internal pressure, the atmosphere opening valve can be opened in a state where the suction section 39 is brought into close contact with the print head 34 to discharge the waste liquid L remaining in the suction section 39. Then, when the waste liquid L is accumulated in the waste liquid storage tank 403, the waste liquid L is fed from the waste liquid storage tank 403 to the buffer 404. At this time, the switching valve 402 is brought into the closed state, and the decompression pump 405 brings the inner chamber 404a of the buffer 404 into the decompressed state.

As a result, the center of the film-like valve 404c is pulled toward the inner chamber 404a against the biasing of the spring 404e, and the volume of the inner chamber 404b is expanded. Therefore, the internal pressure of the inner chamber 404b is lowered, and the waste liquid L flows into the inner chamber 404b from the waste liquid storage tank 403 via the check valve V1. In order to prevent the inflow of air from the waste liquid storage tank 403 to the downstream, a sensor or the like for detecting the storage amount of the waste liquid L may be disposed in the waste liquid storage tank 403. The above-described control section may stop the operation of the decompression pump 405 from the detection result of the sensor.

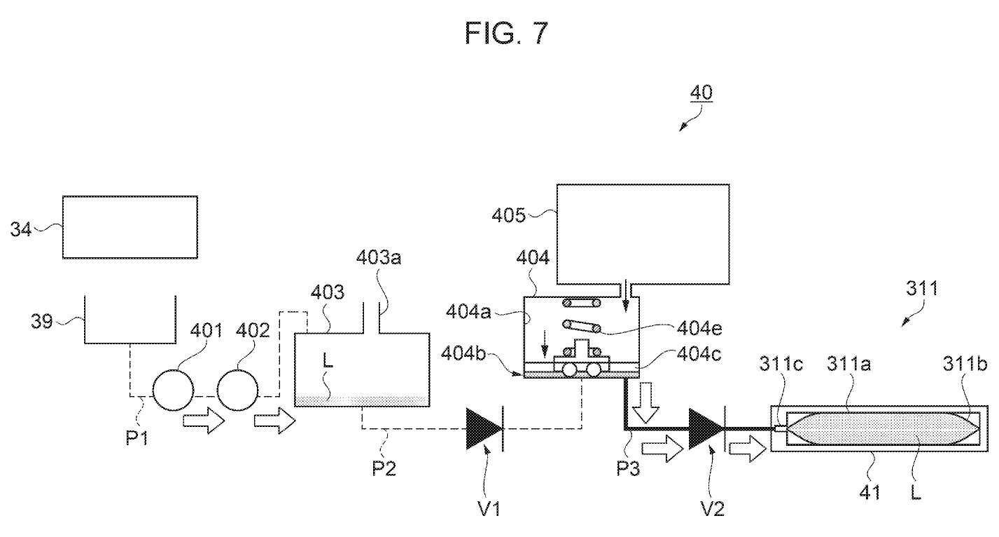

As illustrated in FIG. 7, the waste liquid L is discharged from the inner chamber 404b of the buffer 404 to the used liquid accommodating body 311 mounted on the waste liquid accommodating body holder 41, following the inflow of the waste liquid L to the inner chamber 404b. At this time, the decompression pump 405 is stopped, and the inner chamber 404a of the buffer 404 is opened to the atmosphere. In order to suppress drying in the nozzle of the print head 34, the suction section 39 may be brought into close contact with the print head 34 even when the waste liquid L is sent to the used liquid accommodating body 311.

As a result, the film-like valve 404c is deformed and returned by the biasing of the spring 404e, and the waste liquid L is sent out to the liquid flow path P3 to be pressed against the film-like valve 404c. At this time, the waste liquid L does not flow back to the liquid flow path P2 due to the above-described function of the check valve V1. By repeating the above-mentioned waste liquid L collection operation, the waste liquid L is accommodated each time in the used liquid accommodating body 311, and the bag-like member 311b is swollen. The maintenance operation of the print head 34 and the collection of the waste liquid L by the waste liquid collecting section 40 described above are performed under the control of the control section described above. The waste liquid accommodating body holder 41 may be provided with a detection section that detects the accommodation amount of the waste liquid L accommodated in the used liquid accommodating body 311 or the waste liquid accommodating body 411. The control section described above may stop the accommodation of the waste liquid L when the accommodation amount reaches the upper limit from the detection result of the detection section.

According to the present embodiment, the following effects can be obtained.

The environmental impact can be reduced. Specifically, the used liquid accommodating body 311 is reused as the waste liquid accommodating body 411, and thus the amount of waste is reduced. In addition, resources and energy for separately manufacturing the waste liquid accommodating body 411 are not required. Therefore, the liquid ejecting apparatus 10 that reduces environmental impact, and a method for reusing the liquid accommodating body 311 can be provided.

By making the waste liquid accommodating body holder 41 have the same shape as the liquid accommodating body holder 31, the number of components can be reduced and the manufacturing cost can be reduced as compared with the configuration in which the waste liquid accommodating body holder 41 and the liquid accommodating body holder 31 have different shapes. In addition, since the waste liquid accommodating body holder 41 and the liquid accommodating body holder 31 are integrally formed, the size of the liquid ejecting apparatus 10 can be reduced as compared with a case where the waste liquid accommodating body holder 41 and the liquid accommodating body holder 31 are separately disposed.

What is claimed is:

1. A liquid ejecting apparatus comprising:
a print head;
a liquid accommodating body holder in which a liquid accommodating body is housed; and
a waste liquid accommodating body holder in which a waste liquid accommodating body is housed, wherein
the waste liquid accommodating body holder is formed in the same shape as the liquid accommodating body holder, and is mountable on a used liquid accommodating body.

2. The liquid ejecting apparatus according to claim 1, further comprising:
a suction section that sucks a liquid from the print head; and
a liquid flow path that couples the suction section and the waste liquid accommodating body holder, wherein
the liquid flow path is provided with a waste liquid storage tank that temporarily accommodates the waste liquid sucked from the print head, a switching valve, a buffer, and a decompression pump coupled to the buffer.

3. The liquid ejecting apparatus according to claim 2, wherein
the waste liquid storage tank has an atmosphere opening valve,
when the waste liquid is accommodated in the waste liquid storage tank, the switching valve and the atmosphere opening valve are in an open state,
when the waste liquid is fed from the waste liquid storage tank to the buffer, the switching valve is in a closed state, and the buffer is in a decompressed state by the decompression pump, and
when the waste liquid is discharged from the buffer to the used liquid accommodating body mounted on the waste liquid accommodating body holder, the decompression pump is stopped to open the buffer to an atmosphere.

4. A method for reusing a liquid accommodating body, comprising:
in the liquid ejecting apparatus according to claim 1,
removing the used liquid accommodating body from the liquid accommodating body holder; and
attaching the removed used liquid accommodating body to the waste liquid accommodating body holder.
